(19) United States
(12) Patent Application Publication
(10) Pub. No.: US 2014/0365709 A1
(43) Pub. Date: Dec. 11, 2014

(54) Electronic computer program product and an electronic computer system for producing a location report

(71) Applicant: Jason Matthew Strauss, Albuquerque, NM (US)

(72) Inventor: Jason Matthew Strauss, Albuquerque, NM (US)

(21) Appl. No.: 13/914,581

(22) Filed: Jun. 10, 2013

(51) Int. Cl. G06F 12/02

(52) U.S. Cl. CPC G06F 12/0246
USPC 711/103

(57) ABSTRACT

A method, an electronic computer program product, and an electronic computer system for producing a location report, utilizing look-up tables, the report comprising precautionary statements, emergency metadata, critical operational metadata, executable instructions, National Fire Protection Association ratings, and combinations thereof.

### CROSS-REFERENCE TO RELATED APPLICATIONS

Not applicable.

### STATEMENTS REGARDING FEDERALLY SPONSORED RESEARCH AND DEVELOPMENT

Not applicable.

### BACKGROUND

The embodiments of the present invention satisfy the needs of having a better method for producing a location report.

Information relevant to attempts to address these problems can be found in U.S. Pat. Nos. 8,401,514; 8,275,352; 8,270,936; 8,045,953; and 8,339,251; which are not admitted to be prior art with respect to the present invention by its mention in this Background Section. However, it is desirable to have a better method than is disclosed in the references.

### SUMMARY

The embodiments of the present invention are directed to a method and/or device that satisfies the needs set out in the Background section.

The embodiments of the present invention comprise a method for producing a location report, comprising:

receiving a first man-made location;
determining, utilizing a first look-up table relating man-made locations and utility lines and utility shut-offs, a first geofence, wherein the first geofence encompasses the first man-made location and a first set of utility shut-offs pertaining to utility lines located within the first man-made location, wherein the first set of utility shut-offs may lie outside of the first man-made location;
determining, utilizing a second look-up table relating utility shut-offs and utility lines, a first set of utility lines comprising utility lines pertaining to the first set of utility shut-offs;

determining, utilizing the first look-up table relating man-made locations and utility lines and utility shut-offs, a first set of man-made locations comprising all man-made locations pertaining to the first set of utility lines;

determining a second geofence, wherein the second geofence encompasses the first geofence and the first set of utility lines and the first set of man-made locations;

determining, utilizing a third look-up table relating man-made locations and precautionary statements, precautionary statements pertaining to man-made locations within the second geofence;
determining, utilizing a fourth look-up table relating man-made locations and emergency metadata, emergency metadata pertaining to man-made locations within the second geofence;
determining, utilizing a fifth look-up table relating man-made locations and critical operational metadata, critical operational metadata pertaining to man-made locations within the second geofence;
determining, utilizing a sixth look-up table relating man-made locations and executable instructions, executable instructions pertaining to man-made locations within the second geofence;
determining, utilizing a seventh look-up table relating man-made locations and National Fire Protection Association ratings, National Fire Protection Association ratings pertaining to man-made locations within the second geofence;
determining, utilizing a eighth look-up table relating precautionary statements and emergency metadata and critical operational metadata and executable instructions and National Fire Protection Association ratings and report format, a first report format; and
compiling a first report, wherein the first report presents in a first report format and comprises data selected from the group consisting of: precautionary statements, emergency metadata, critical operational metadata, executable instructions, National Fire Protection Association ratings, and combinations thereof.

Optionally, boundaries of the first geofence are drawn to minimize an area encompassed by the first geofence, subject to a constraint that the first geofence encompasses the first man-made location and a first set of utility shut-offs pertaining to utility lines located within the first man-made location.

Optionally, boundaries of the first geofence are drawn to comprise a first circle, wherein a center point of the first circle is set at the first man-made location, and wherein a circle radius of the first circle is determined by a greatest distance between the first man-made location and utility cut-offs in first set of utility cut-offs.

Optionally, boundaries of the first geofence are drawn by connecting the first set of utility shut-offs with straight line boundaries.

Optionally, boundaries of the second geofence are drawn to minimize an area encompassed by the second geofence, subject to a constraint that the second geofence encompasses the first geofence and the first set of utility lines.

Optionally, boundaries of the second geofence are drawn to comprise a second circle, wherein a center point of the second circle is set at the first man-made location, and wherein a circle radius of the second circle is determined by a greatest distance between the first man-made location and utility lines in first set of utility lines.

Optionally, boundaries of the second geofence are drawn with straight line boundaries, subject to a constraint that the second geofence encompasses the first geofence and the first set of utility lines.

Optionally, the report further comprises, for the first man-made location, graphics selected from the group consisting of: maps, floorplans, blueprints, insurance maps, photographs, and combinations thereof.

Optionally, the report further comprises, for each man-made location listed within the second geofence, graphics selected from the group consisting of: maps, floorplans, blueprints, insurance maps, photographs, and combinations thereof.

Optionally, the eighth look-up table further relates man-made locations to precautionary statements and emergency metadata and critical operational metadata and executable instructions and National Fire Protection Association ratings and report format; wherein the first report format distinguishes between man-made locations in the first set of man-made locations, and man-made locations encompassed by the second geofence but not in the first set of man-made locations.

Optionally, the embodiments of the invention comprise an electronic computer program product, comprising an electronic computer-readable storage medium having an electronic computer-readable program code therein, said computer readable program code comprising an algorithm configured to implement a method for producing a location report, said method comprising:

receiving into volatile memory a first man-made location;
determining, utilizing an electronic processor and a first look-up table stored in non-volatile memory and relating man-made locations and utility shut-offs, a first geofence, wherein the first geofence encompasses the first man-made location and a first set of utility shut-offs pertaining to utility lines located within the first man-made location, wherein the first set of utility shut-offs may lie outside of the first geofence;
determining, utilizing a second look-up table stored in non-volatile memory and relating utility shut-offs and utility lines, a first set of utility lines comprising utility lines pertaining to the first set of utility shut-offs;

determining, utilizing the first look-up table relating stored in non-volatile memory and man-made locations and utility lines and utility shut-offs, a first set of man-made locations comprising all man-made locations pertaining to the first set of utility lines;

determining a second geofence, wherein the second geofence encompasses the first geofence and the first set of utility lines and the first set of man-made locations;

determining, utilizing a third look-up table stored in non-volatile memory and relating man-made locations and precautionary statements, precautionary statements pertaining to man-made locations within the second geofence;
determining, utilizing a fourth look-up table stored in non-volatile memory and relating man-made locations and emergency metadata, emergency metadata pertaining to man-made locations within the second geofence;
determining, utilizing a fifth look-up table stored in non-volatile memory and relating man-made locations and critical operational metadata, critical operational metadata pertaining to man-made locations within the second geofence;
determining, utilizing a sixth look-up table stored in non-volatile memory and relating man-made locations and executable instructions, executable instructions pertaining to man-made locations within the second geofence;
determining, utilizing a seventh look-up table stored in non-volatile memory and relating man-made locations and National Fire Protection Association ratings, National Fire Protection Association ratings pertaining to man-made locations within the second geofence;
determining, utilizing a eighth look-up table stored in non-volatile memory and relating precautionary statements and emergency metadata and critical operational metadata and executable instructions and National Fire Protection Association ratings and report format, a first report format; and
   compiling a first report, wherein the first report presents in a first report format and comprises data selected from the group consisting of: precautionary statements, emergency metadata, critical operational metadata, executable instructions, National Fire Protection Association ratings, and combinations thereof.

Optionally, boundaries of the first geofence are drawn to minimize an area encompassed by the first geofence, subject to a constraint that the first geofence encompasses the first man-made location and a first set of utility shut-offs pertaining to utility lines located within the first man-made location.

Optionally, boundaries of the first geofence are drawn to comprise a first circle, wherein a center point of the first circle is set at the first man-made location, and wherein a circle radius of the first circle is determined by a greatest distance between the first man-made location and utility cut-offs in first set of utility cut-offs.

Optionally, boundaries of the first geofence are drawn by connecting the first set of utility shut-offs with straight line boundaries.

Optionally, boundaries of the second geofence are drawn to minimize an area encompassed by the second geofence, subject to a constraint that the second geofence encompasses the first geofence and the first set of utility lines.

Optionally, boundaries of the second geofence are drawn to comprise a second circle, wherein a center point of the second circle is set at the first man-made location, and wherein a circle radius of the second circle is determined by a greatest distance between the first man-made location and utility lines in first set of utility lines.

Optionally, boundaries of the second geofence are drawn with straight line boundaries, subject to a constraint that the second geofence encompasses the first geofence and the first set of utility lines.

Optionally, the report further comprises, for the first man-made location, digital graphics files selected from the group consisting of: digital maps, digital floorplans, digital photographs, and combinations thereof.

Optionally, the report further comprises, for each man-made location listed within the second geofence, digital graphics files selected from the group consisting of: digital maps, digital floorplans, digital photographs, and combinations thereof.

Optionally, the eighth look-up table further relates man-made locations to precautionary statements and emergency metadata and critical operational metadata and executable instructions and National Fire Protection Association ratings and report format; wherein the first report format distinguishes between man-made locations in the first set of man-made locations, and man-made locations encompassed by the second geofence but not in the first set of man-made locations.

Optionally, the embodiments of the present invention comprise an electronic computer system comprising an electronic processor and an electronic computer-readable storage medium, said storage medium containing program code configured to be executed by the electronic processor to implement a method for producing a location report, said method comprising:

receiving into volatile memory a first man-made location;
determining, utilizing a first look-up table stored in non-volatile memory and relating man-made locations and utility shut-offs, a first geofence, wherein the first geofence encompasses the first man-made location and a first set of utility shut-offs pertaining to utility lines located within the first man-made location, wherein the first set of utility shut-offs may lie outside of the first geofence;
determining, utilizing a second look-up table stored in non-volatile memory and relating utility shut-offs and utility lines, a first set of utility lines comprising utility lines pertaining to the first set of utility shut-offs;

determining, utilizing the first look-up table stored in non-volatile memory and relating man-made locations and utility lines and utility shut-offs, a first set of man-made locations comprising all man-made locations pertaining to the first set of utility lines;

determining a second geofence, wherein the second geofence encompasses the first geofence and the first set of utility lines and the first set of man-made locations;

determining, utilizing a third look-up table stored in non-volatile memory and relating man-made locations and precautionary statements, precautionary statements pertaining to man-made locations within the second geofence;
determining, utilizing a fourth look-up table stored in non-volatile memory and relating man-made locations and emergency metadata, emergency metadata pertaining to man-made locations within the second geofence;
determining, utilizing a fifth look-up table stored in non-volatile memory and relating man-made locations and critical operational metadata, critical operational metadata pertaining to man-made locations within the second geofence;
determining, utilizing a sixth look-up table stored in non-volatile memory and relating man-made locations and executable instructions, executable instructions pertaining to man-made locations within the second geofence;
determining, utilizing a seventh look-up table stored in non-volatile memory and relating man-made locations and National Fire Protection Association ratings, National Fire Protection Association ratings pertaining to man-made locations within the second geofence;
determining, utilizing a eighth look-up table stored in non-volatile memory and relating precautionary statements and emergency metadata and critical operational metadata and executable instructions and National Fire Protection Association ratings and report format, a first report format; and
compiling a first report, wherein the first report presents in a first report format and comprises data selected from the group consisting of: precautionary statements, emergency metadata, critical operational metadata, executable instructions, National Fire Protection Association ratings, and combinations thereof.

Optionally, boundaries of the first geofence are drawn to minimize an area encompassed by the first geofence, subject to constraints that the first geofence encompasses the first man-made location and a first set of utility shut-offs pertaining to utility lines located within the first man-made location.

Optionally, boundaries of the first geofence are drawn to comprise a first circle, wherein a center point of the first circle is set at the first man-made location, and wherein a circle radius of the first circle is determined by a greatest distance between the first man-made location and utility cut-offs in first set of utility cut-offs.

Optionally, boundaries of the first geofence are drawn by connecting the first set of utility shut-offs with straight line boundaries.

Optionally, boundaries of the second geofence are drawn to minimize an area encompassed by the second geofence, subject to a constraint that the second geofence encompasses the first geofence and the first set of utility lines.

Optionally, boundaries of the second geofence are drawn to comprise a second circle, wherein a center point of the second circle is set at the first man-made location, and wherein a circle radius of the second circle is determined by a greatest distance between the first man-made location and utility lines in first set of utility lines.

Optionally, boundaries of the second geofence are drawn with straight line boundaries, subject to a constraint that the second geofence encompasses the first geofence and the first set of utility lines.

Optionally, the report further comprises, for the first man-made location, digital graphics files selected from the group consisting of: digital maps, digital floorplans, digital photographs, and combinations thereof.

Optionally, the report further comprises, for each man-made location listed within the second geofence, digital graphics files selected from the group consisting of: digital maps, digital floorplans, digital photographs, and combinations thereof.

In the embodiments of the present invention, the user inputs all look-up tables. The report format in particular is determined by the eighth look-up table as input by user.

Optionally, the eighth look-up table further relates man-made locations to precautionary statements and emergency metadata and critical operational metadata and executable instructions and National Fire Protection Association ratings and report format; wherein the first report format distinguishes between man-made locations in the first set of man-made locations, and man-made locations encompassed by the second geofence but not in the first set of man-made locations.

### Some Advantages of the Embodiments of the Invention

In the embodiments of the present invention, the algorithm can be run for each man-made location combination, and then the reports can be loaded into client devices so that they can be available offline.

These and other advantages will become apparent as the embodiments of the invention are used.

### DRAWINGS

These and other features, aspects and advantages of the embodiments of the method will become better understood with reference to the following description, appended claim and accompanying drawings where:

FIG. 1 shows the identification of utility lines within the first man-made location;

FIG. 2 shows the identification of the shut-offs pertaining to the utility lines within the first man-made location;

FIG. 3 shows the identification of all man-made locations pertaining to the forementioned shut-offs;

FIG. 4 shows the identification of all man-made locations in proximity of the first man-made location, e.g. within the first geofence;

FIG. 5 shows the distinction between man-made locations connected to the first man-made location, and those not connected (circles);

FIGS. 6, 7, and 8 show the second geofence, where

FIG. 6 shows the minimum area method,

FIG. 7 shows the connecting by straight lines method, and

FIG. 8 shows the radius method.

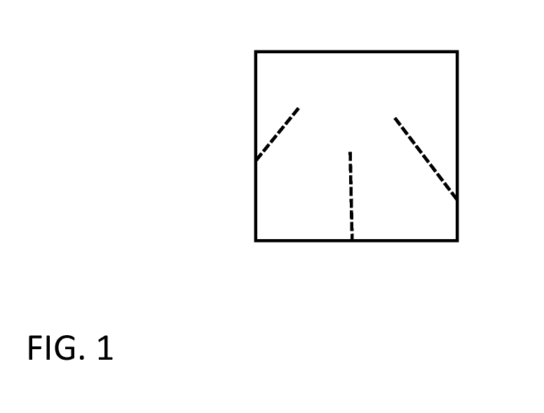

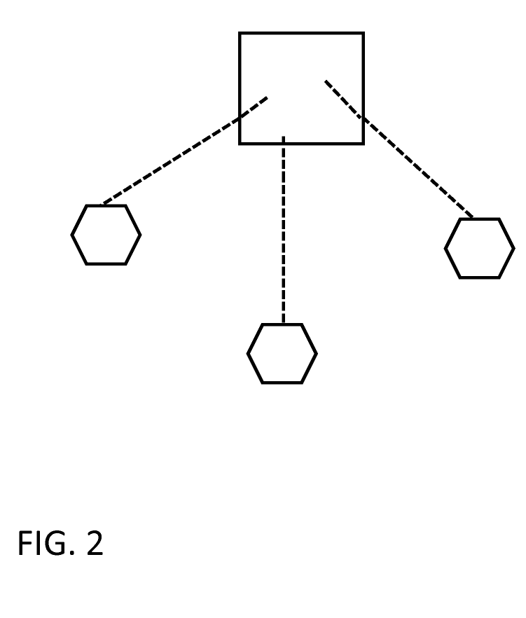

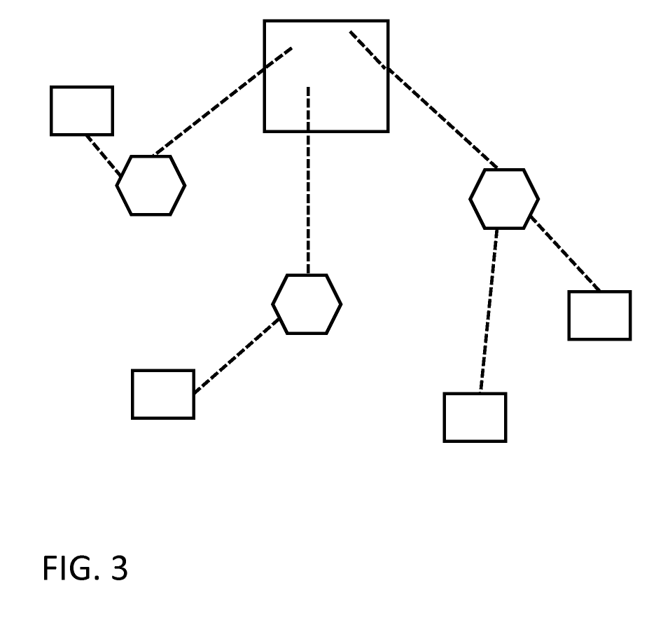

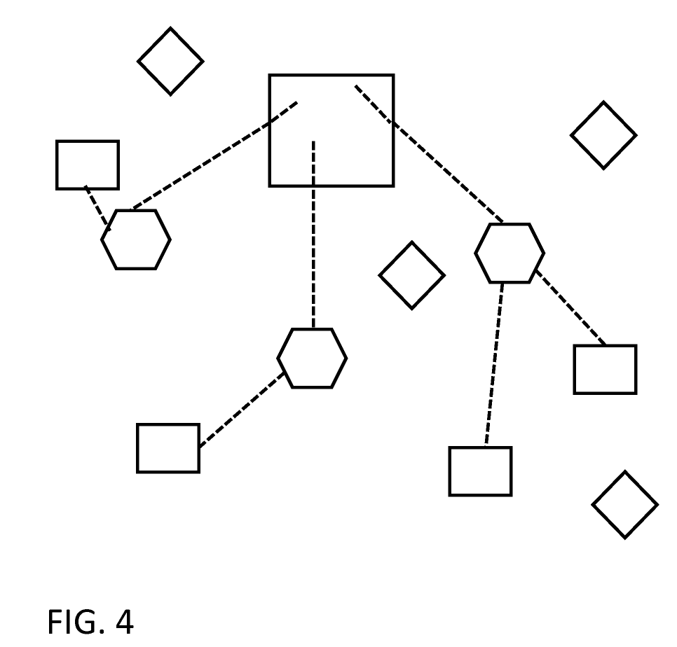

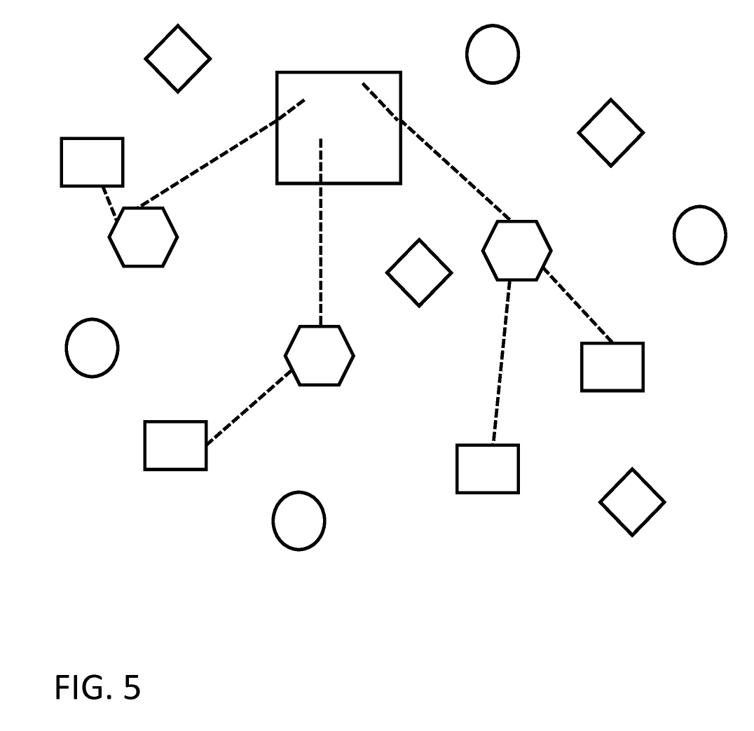

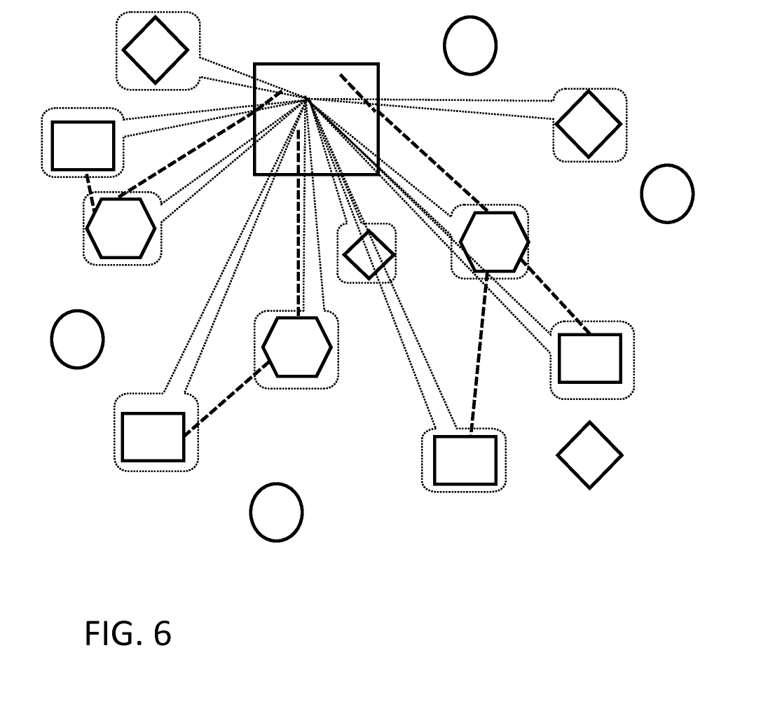

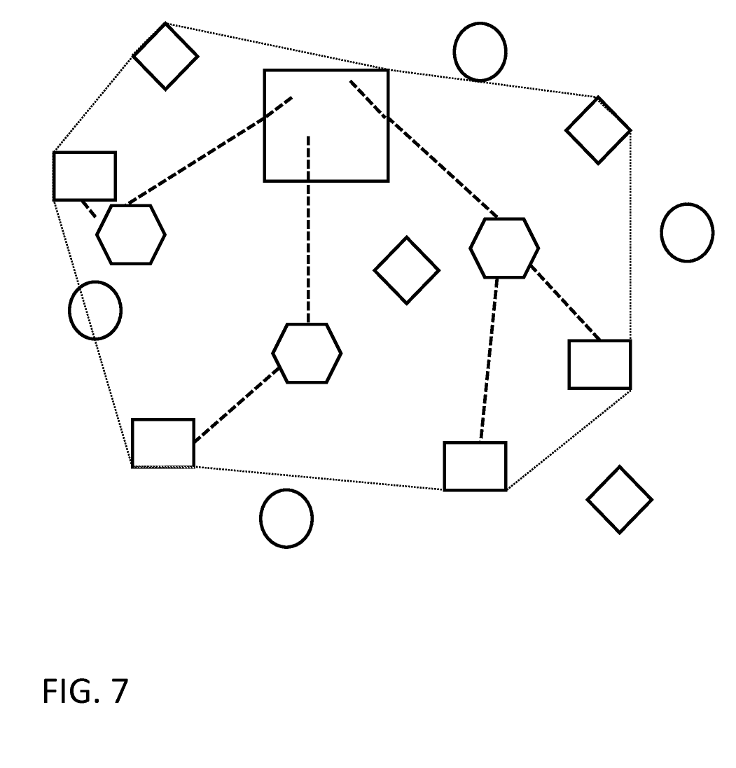

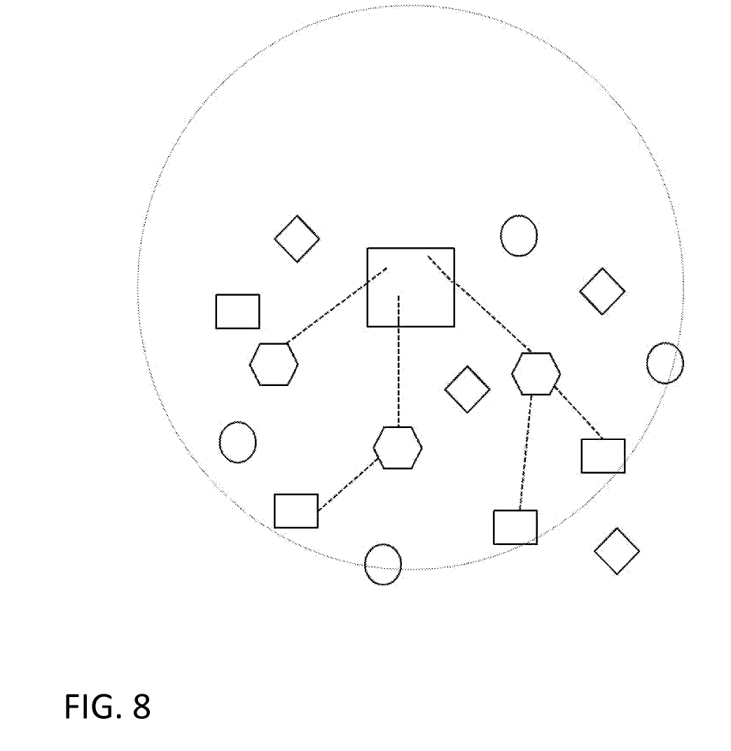

### REFERENCE NUMERALS FOR DRAWINGS

None.

### DESCRIPTION

### Definitions

According to Wikipedia, (http://en.wikipedia.org/wiki/Computer_memory), volatile memory is defined as follows: “Volatile memory is computer memory that requires power to maintain the stored information. Most modern semiconductor volatile memory is either Static RAM (see SRAM) or dynamic RAM (see DRAM). SRAM retains its contents as long as the power is connected and is easy to interface to but uses six transistors per bit. Dynamic RAM is more complicated to interface to and control and needs regular refresh cycles to prevent its contents being lost. However, DRAM uses only one transistor and a capacitor per bit, allowing it to reach much higher densities and, with more bits on a memory chip, be much cheaper per bit. SRAM is not worthwhile for desktop system memory, where DRAM dominates, but is used for their cache memories. SRAM is commonplace in small embedded systems, which might only need tens of kilobytes or less. Forthcoming volatile memory technologies that hope to replace or compete with SRAM and DRAM include Z-RAM, TTRAM, A-RAM and ETA RAM.”

According to Wikipedia, (http://en.wikipedia.org/wiki/Computer_memory), non-volatile memory is defined as follows: “Non-volatile memory is computer memory that can retain the stored information even when not powered. Examples of non-volatile memory include read-only memory (see ROM), flash memory, most types of magnetic computer storage devices (e.g. hard disks, floppy discs and magnetic tape), optical discs, and early computer storage methods such as paper tape and punched cards. Forthcoming non-volatile memory technologies include FeRAM, CBRAM, PRAM, SONOS, RRAM, Racetrack memory, NRAM and Millipede.”

Man-made locations comprise geographical areas and all man-made structures situated within the geographical areas, such as buildings, groups of buildings such as campuses, facilities such as water treatment plants, and the like.

Situations comprise non-ordinary events such as fires, shooters and natural disasters; water leaks; and in general, incidents requiring attention by operations personnel to maintain uninterrupted availability to occupants of assets.

Critical operational metadata comprises man-made locations of and information regarding critical operational components such as main shut-off valves for water and gas, sewer ejector pumps, electrical panels, emergency generators, fire protection valves, and the like. It relates to activities that are happening within the building, such as animal colonies, storage of highly volatile materials and the systems that support them.

Emergency metadata comprises building identification information, lists of responsible personnel, public relations plans, property and asset and man-made location priorities, emergency plans, access plans and codes and protocols, and the like.

Precautionary statements comprise danger/warning/caution/notice statements.

Executable instructions are procedures that are not self-executing but must be implemented by operations personnel.

National Fire Protection Association (NFPA) ratings advise emergency response personnel via the hazard diamond sticker of hazards they may encounter when entering the room in response to fire or other situations. According to Wikipedia (http://en.wikipedia.org/wiki/NFPA_{—}704),

“NFPA 704: Standard System for the Identification of the Hazards of Materials for Emergency Response is a standard maintained by the U.S.-based National Fire Protection Association. First “tentatively adopted as a guide” in 1960, and revised several times since then, it defines the colloquial “fire diamond” used by emergency personnel to quickly and easily identify the risks posed by hazardous materials. This helps determine what, if any, special equipment should be used, procedures followed, or precautions taken during the initial stages of an emergency response . . . . The four divisions are typically color-coded, with blue indicating level of health hazard, red indicating flammability, yellow (chemical) reactivity, and white containing special codes for unique hazards. Each of health, flammability and reactivity is rated on a scale from 0 (no hazard) to 4 (severe risk).”

Geofence is a geographical border encompassing a man-made location. Located within a geofence means located geographically within the borders determined by the geofence, just as a house is located within the borders of a fence on a property line. Determining a geofence means determining the geographical man-made location of the geofence.

Encompassing is a generalization of the concept of encircling, in that it surrounds but does not necessarily require a circle.

Utilities comprise chilled water, electricity, natural gas, sewer, domestic water, and the like.

Utility shut-off is a mechanism for reversibly stopping the operation of a utility line by reversibly stopping the flow of materials or services. A utility shut-off pertains to a utility line when the shut-off can be operated to shut off the flow of materials or services through that utility line. A utility line pertains to a utility shut-off when the flow of materials or services through that utility line can be reversibly stopped through operation of the shut-off.

Reversibly stopping means stopping in such a way that the item can be restarted. It can be automatic or manual.

Utility line means any conduit and its related facilities including pipe or cable, by which an operator furnishes or transports materials or services.

Operator means any person who furnishes or transports any of the following materials or services by means of a utility line: Flammable, natural toxic or corrosive gas; Petroleum, petroleum products and hazardous liquids; Electricity; Sanitary sewer; Communications; and Water.

Person means any individual, partnership, association, corporation, state subdivision or instrumentality of the state, or the legal representative thereof.

Digital maps comprise Internet maps, maps contained within electronic files, and the like.

### DESCRIPTION OF THE PREFERRED EMBODIMENT AND BEST MODE

As shown in the figures, the preferred embodiment and best mode of the present invention comprise an electronic computer program product, comprising an electronic computer-readable storage medium having an electronic computer-readable program code therein, said computer readable program code comprising an algorithm configured to implement a method for producing a location report, said method comprising:

receiving into volatile memory a first man-made location;

determining, utilizing an electronic processor and a first look-up table stored in non-volatile memory and relating man-made locations and utility shut-offs, a first geofence, wherein the first geofence encompasses the first man-made location and a first set of utility shut-offs pertaining to utility lines located within the first man-made location, wherein the first set of utility shut-offs may lie outside of the first geofence;

determining, utilizing a second look-up table stored in non-volatile memory and relating utility shut-offs and utility lines, a first set of utility lines comprising utility lines pertaining to the first set of utility shut-offs;

determining, utilizing the first look-up table stored in non-volatile memory and relating man-made locations and utility lines and utility shut-offs, a first set of man-made locations comprising all man-made locations pertaining to the first set of utility lines;

determining a second geofence, wherein the second geofence encompasses the first geofence and the first set of utility lines and the first set of man-made locations;

determining, utilizing a third look-up table stored in non-volatile memory and relating man-made locations and precautionary statements, precautionary statements pertaining to man-made locations within the second geofence;

determining, utilizing a fourth look-up table stored in non-volatile memory and relating man-made locations and emergency metadata, emergency metadata pertaining to man-made locations within the second geofence;

determining, utilizing a fifth look-up table stored in non-volatile memory and relating man-made locations and critical operational metadata, critical operational metadata pertaining to man-made locations within the second geofence;

determining, utilizing a sixth look-up table stored in non-volatile memory and relating man-made locations and executable instructions, executable instructions pertaining to man-made locations within the second geofence;

determining, utilizing a seventh look-up table stored in non-volatile memory and relating man-made locations and National Fire Protection Association ratings, National Fire Protection Association ratings pertaining to man-made locations within the second geofence;

determining, utilizing a eighth look-up table stored in non-volatile memory and relating precautionary statements and emergency metadata and critical operational metadata and executable instructions and National Fire Protection Association ratings and report format, a first report format; and

compiling a first report, wherein the first report presents in a first report format and comprises data selected from the group consisting of: precautionary statements, emergency metadata, critical operational metadata, executable instructions, National Fire Protection Association ratings, and combinations thereof.

Optionally, boundaries of the first geofence are drawn to minimize an area encompassed by the first geofence, subject to a constraint that the first geofence encompasses the first man-made location and a first set of utility shut-offs pertaining to utility lines located within the first man-made location.

Optionally, boundaries of the first geofence are drawn to comprise a first circle, wherein a center point of the first circle is set at the first man-made location, and wherein a circle radius of the first circle is determined by a greatest distance between the first man-made location and utility cut-offs in first set of utility cut-offs.

Optionally, boundaries of the first geofence are drawn by connecting the first set of utility shut-offs with straight line boundaries.

Optionally, boundaries of the second geofence are drawn to minimize an area encompassed by the second geofence, subject to a constraint that the second geofence encompasses the first geofence and the first set of utility lines.

Optionally, boundaries of the second geofence are drawn to comprise a second circle, wherein a center point of the second circle is set at the first man-made location, and wherein a circle radius of the second circle is determined by a greatest distance between the first man-made location and utility lines in first set of utility lines.

Optionally, boundaries of the second geofence are drawn with straight line boundaries, subject to a constraint that the second geofence encompasses the first geofence and the first set of utility lines.

Optionally, the report further comprises, for the first man-made location, digital graphics files selected from the group consisting of: digital maps, digital floorplans, digital photographs, and combinations thereof.

Optionally, the report further comprises, for each man-made location listed within the second geofence, digital graphics files selected from the group consisting of: digital maps, digital floorplans, digital photographs, and combinations thereof.

Optionally, the eighth look-up table further relates man-made locations to precautionary statements and emergency metadata and critical operational metadata and executable instructions and National Fire Protection Association ratings and report format; wherein the first report format distinguishes between man-made locations in the first set of man-made locations, and man-made locations encompassed by the second geofence but not in the first set of man-made locations.

Some advantages of the embodiments of the apparatus were previously enumerated in the Summary section. Every advantageous feature does not need to be incorporated into every embodiment of the apparatus and/or methods.

Although these versions of the invention have been described in considerable detail, other versions are possible. For example, embodiments can comprise combinations of the features described herein, such as combinations of the dependent claims. Therefore, the spirit and scope of the appended claims should not be limited to the description of the versions contained therein.

I claim:

1. An electronic computer program product, comprising an electronic computer-readable storage medium having an electronic computer-readable program code therein, said computer readable program code comprising an algorithm configured to implement a method for producing a location report, said method comprising:
receiving into volatile memory a first man-made location;
determining, utilizing an electronic processor and a first look-up table stored in non-volatile memory and relating man-made locations and utility shut-offs, a first geofence, wherein the first geofence encompasses the first man-made location and a first set of utility shut-offs pertaining to utility lines located within the first man-made location, wherein the first set of utility shut-offs may lie outside of the first geofence;
determining, utilizing a second look-up table stored in non-volatile memory and relating utility shut-offs and utility lines, a first set of utility lines comprising utility lines pertaining to the first set of utility shut-offs;
determining, utilizing the first look-up table stored in non-volatile memory and relating man-made locations and utility lines and utility shut-offs, a first set of man-made locations comprising all man-made locations pertaining to the first set of utility lines;
determining a second geofence, wherein the second geofence encompasses the first geofence and the first set of utility lines and the first set of man-made locations;
determining, utilizing a third look-up table stored in non-volatile memory and relating man-made locations and precautionary statements, precautionary statements pertaining to man-made locations within the second geofence;
determining, utilizing a fourth look-up table stored in non-volatile memory and relating man-made locations and emergency metadata, emergency metadata pertaining to man-made locations within the second geofence;
determining, utilizing a fifth look-up table stored in non-volatile memory and relating man-made locations and critical operational metadata, critical operational metadata pertaining to man-made locations within the second geofence;
determining, utilizing a sixth look-up table stored in non-volatile memory and relating man-made locations and executable instructions, executable instructions pertaining to man-made locations within the second geofence;
determining, utilizing a seventh look-up table stored in non-volatile memory and relating man-made locations and National Fire Protection Association ratings, National Fire Protection Association ratings pertaining to man-made locations within the second geofence;
determining, utilizing a eighth look-up table stored in non-volatile memory and relating precautionary statements and emergency metadata and critical operational metadata and executable instructions and National Fire Protection Association ratings and report format, a first report format; and
compiling a first report, wherein the first report presents in a first report format and comprises data selected from the group consisting of: precautionary statements, emergency metadata, critical operational metadata, executable instructions, National Fire Protection Association ratings, and combinations thereof.

2. The method of claim 1, wherein boundaries of the first geofence are drawn to minimize an area encompassed by the first geofence, subject to a constraint that the first geofence encompasses the first man-made location and a first set of utility shut-offs pertaining to utility lines located within the first man-made location.

3. The method of claim 1, wherein boundaries of the first geofence are drawn to comprise a first circle, wherein a center point of the first circle is set at the first man-made location, and wherein a circle radius of the first circle is determined by a greatest distance between the first man-made location and utility cut-offs in first set of utility cut-offs.

4. The method of claim 1, wherein boundaries of the first geofence are drawn by connecting the first set of utility shut-offs with straight line boundaries.

5. The method of claim 1, wherein boundaries of the second geofence are drawn to minimize an area encompassed by the second geofence, subject to a constraint that the second geofence encompasses the first geofence and the first set of utility lines.

6. The method of claim 1, wherein boundaries of the second geofence are drawn to comprise a second circle, wherein a center point of the second circle is set at the first man-made location, and wherein a circle radius of the second circle is determined by a greatest distance between the first man-made location and utility lines in first set of utility lines.

7. The method of claim 1, wherein boundaries of the second geofence are drawn with straight line boundaries, subject to a constraint that the second geofence encompasses the first geofence and the first set of utility lines.

8. The method of claim 1, wherein the report further comprises, for the first man-made location, digital graphics files selected from the group consisting of: digital maps, digital floorplans, digital photographs, and combinations thereof.

9. The method of claim 1, wherein the report further comprises, for each man-made location listed within the second geofence, digital graphics files selected from the group consisting of: digital maps, digital floorplans, digital photographs, and combinations thereof.

10. The method of claim 1, wherein the eighth look-up table further relates man-made locations to precautionary statements and emergency metadata and critical operational metadata and executable instructions and National Fire Protection Association ratings and report format; wherein the first report format distinguishes between man-made locations in the first set of man-made locations, and man-made locations encompassed by the second geofence but not in the first set of man-made locations.

11. An electronic computer system comprising an electronic processor and an electronic computer-readable storage medium, said storage medium containing program code configured to be executed by the electronic processor to implement a method for producing a location report, said method comprising:
receiving into volatile memory a first man-made location;
determining, utilizing a first look-up table stored in non-volatile memory and relating man-made locations and utility shut-offs, a first geofence, wherein the first geofence encompasses the first man-made location and a first set of utility shut-offs pertaining to utility lines located within the first man-made location, wherein the first set of utility shut-offs may lie outside of the first geofence;
determining, utilizing a second look-up table stored in non-volatile memory and relating utility shut-offs and utility lines, a first set of utility lines comprising utility lines pertaining to the first set of utility shut-offs;
determining, utilizing the first look-up table stored in non-volatile memory and relating man-made locations and utility lines and utility shut-offs, a first set of man-made locations comprising all man-made locations pertaining to the first set of utility lines;
determining a second geofence, wherein the second geofence encompasses the first geofence and the first set of utility lines and the first set of man-made locations;
determining, utilizing a third look-up table stored in non-volatile memory and relating man-made locations and precautionary statements, precautionary statements pertaining to man-made locations within the second geofence;
determining, utilizing a fourth look-up table stored in non-volatile memory and relating man-made locations and emergency metadata, emergency metadata pertaining to man-made locations within the second geofence;
determining, utilizing a fifth look-up table stored in non-volatile memory and relating man-made locations and critical operational metadata, critical operational metadata pertaining to man-made locations within the second geofence;
determining, utilizing a sixth look-up table stored in non-volatile memory and relating man-made locations and executable instructions, executable instructions pertaining to man-made locations within the second geofence;
determining, utilizing a seventh look-up table stored in non-volatile memory and relating man-made locations and National Fire Protection Association ratings, National Fire Protection Association ratings pertaining to man-made locations within the second geofence;
determining, utilizing a eighth look-up table stored in non-volatile memory and relating precautionary statements and emergency metadata and critical operational metadata and executable instructions and National Fire Protection Association ratings and report format, a first report format; and
compiling a first report, wherein the first report presents in a first report format and comprises data selected from the group consisting of: precautionary statements, emergency metadata, critical operational metadata, executable instructions, National Fire Protection Association ratings, and combinations thereof.

12. The method of claim 11, wherein boundaries of the first geofence are drawn to minimize an area encompassed by the first geofence, subject to constraints that the first geofence encompasses the first man-made location and a first set of utility shut-offs pertaining to utility lines located within the first man-made location.

13. The method of claim 11, wherein boundaries of the first geofence are drawn to comprise a first circle, wherein a center point of the first circle is set at the first man-made location, and wherein a circle radius of the first circle is determined by a greatest distance between the first man-made location and utility cut-offs in first set of utility cut-offs.

14. The method of claim 11, wherein boundaries of the first geofence are drawn by connecting the first set of utility shut-offs with straight line boundaries.

15. The method of claim 11, wherein boundaries of the second geofence are drawn to minimize an area encompassed by the second geofence, subject to a constraint that the second geofence encompasses the first geofence and the first set of utility lines.

16. The method of claim 11, wherein boundaries of the second geofence are drawn to comprise a second circle, wherein a center point of the second circle is set at the first man-made location, and wherein a circle radius of the second circle is determined by a greatest distance between the first man-made location and utility lines in first set of utility lines.

17. The method of claim 11, wherein boundaries of the second geofence are drawn with straight line boundaries, subject to a constraint that the second geofence encompasses the first geofence and the first set of utility lines.

18. The method of claim 11, wherein the report further comprises, for the first man-made location, digital graphics files selected from the group consisting of: digital maps, digital floorplans, digital photographs, and combinations thereof.

19. The method of claim 11, wherein the report further comprises, for each man-made location listed within the second geofence, digital graphics files selected from the group consisting of: digital maps, digital floorplans, digital photographs, and combinations thereof.

20. The method of claim 11, wherein the eighth look-up table further relates man-made locations to precautionary statements and emergency metadata and critical operational metadata and executable instructions and National Fire Protection Association ratings and report format; wherein the first report format distinguishes between man-made locations in the first set of man-made locations, and man-made locations encompassed by the second geofence but not in the first set of man-made locations.
